(19) United States
(12) Patent Application Publication
(10) Pub. No.: US 2004/0015524 A1
(43) Pub. Date: Jan. 22, 2004

(54) Method and apparatus for managing digitally-stored media files

(76) Inventors: Robert Eugene Chalstrom, Fort Collins, CO (US); Mark D. Seaman, Greeley, CO (US); Gregory A. Brake, Fort Collins, CO (US); Mike A. Farrell, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/199,553

(22) Filed: Jul. 19, 2002

(51) Int. Cl. G06F 17/30

(52) U.S. Cl. 707/206

(57) ABSTRACT

A method and apparatus for managing digitally-stored media files. The method involves maintaining a decay function, and then periodically applying the decay function to at least a portion of the digitally-stored media files. The apparatus includes computer-readable media, and program code stored on the computer-readable media. The program code comprises program code for maintaining a decay function, and program code for periodically applying the decay function to at least a portion of the digitally-stored media files.

### FIELD OF THE INVENTION

The invention pertains to the management of digitally-stored media files.

### BACKGROUND OF THE INVENTION

As defined herein, digitally-stored media files comprise digitally-stored image files (e.g., photos), audio files, video files, and multimedia combinations thereof (e.g., audiovisual files and slide shows).

Many computer users are experiencing exponential growth in their number of digitally-stored media files. This is due, in part, to the ever-increasing number of digital input devices that are available to computer users. Digital input devices include such devices as digital cameras, digital video cameras, scanners, and MP3 audio (Moving Picture Experts Group layer-3 audio) players.

Growth in the number of digitally-stored media files has led to numerous problems. For example, many users are unsure how to manage their media files. To complicate matters, media files are often relatively large in comparison to other files (e.g., text files and operating system files). As a result, media files that are not effectively managed have a tendency to overtake an inordinate percentage of a computer's available storage resources. This, in turn, limits a user's ability to capture and store additional media files.

To keep up with the growth in their number of digitally-stored media files, users often purchase additional storage resources (e.g., larger and/or additional hard drives, CD-Rs (compact disc recordables), CD-RWs (compact disc rewritables), writable DVD's (digital video discs), and Zip® disks (manufactured by Iomega Corporation)). Other users merely pick and choose which media files to delete. Unfortunately, an ad hoc approach to managing media files is often ineffective. For example, assume that a user takes a digital photo and loads the photo (i.e., an image file) onto the hard drive of his or her computer. The user may then store a backup copy of the photo on a CD-R disc. Later, the user may edit the photo and save an additional, edited copy of the photo on his or her hard drive. Eventually, the user may print the edited photo. Alternatively, or additionally, the user may upload the photo to an online storage repository and photo-printing/sharing service. Once the user has shared his or her photo with friends and family, and printed any copies he or she desires for his or her own records, all photos other than a single backup photo become largely unnecessary. However, users often fail to delete their additional copies of the photo, and months later when they are running low on storage resources, it is a difficult task to determine which photos can be deleted because they are merely edited and/or tailored versions of an original. Likewise, it is an arduous task to determine which photos are important enough to keep at all.

As computer users are well aware, there are many other examples of how an ad hoc approach to media file management can be ineffective.

### SUMMARY OF THE INVENTION

In a first embodiment of the invention, a method for managing digitally-stored media files comprises maintaining a decay function, and then periodically applying the decay function to at least a portion of the digitally-stored media files.

In a second embodiment of the invention, apparatus for managing digitally-stored media files comprises computer-readable media, and program code stored on the computer-readable media. The program code comprises program code for maintaining a decay function, and program code for periodically applying the decay function to at least a portion of the digitally-stored media files.

### BRIEF DESCRIPTION OF THE DRAWINGS

Illustrative and presently preferred embodiments of the invention are illustrated in the drawings, in which:

FIG. 1 illustrates exemplary methods for managing digitally-stored media files in accordance with the invention;

FIG. 2 illustrates the exemplary results of applying a first possible decay function to a digitally-stored media file;

FIG. 3 illustrates the exemplary results of applying a second possible decay function to a digitally-stored media file;

FIG. 4 illustrates the exemplary results of applying a third possible decay function to a digitally-stored media file; and

FIG. 5 illustrates an exemplary computer system for managing digitally-stored media files in accordance with the invention;

FIG. 6 provides an example of how the FIG. 5 computer system might apply a decay function to a digitally-stored media file;

FIG. 7 illustrates an embodiment of the graphical user interface (GUI) illustrated in FIG. 5.

### DESCRIPTION

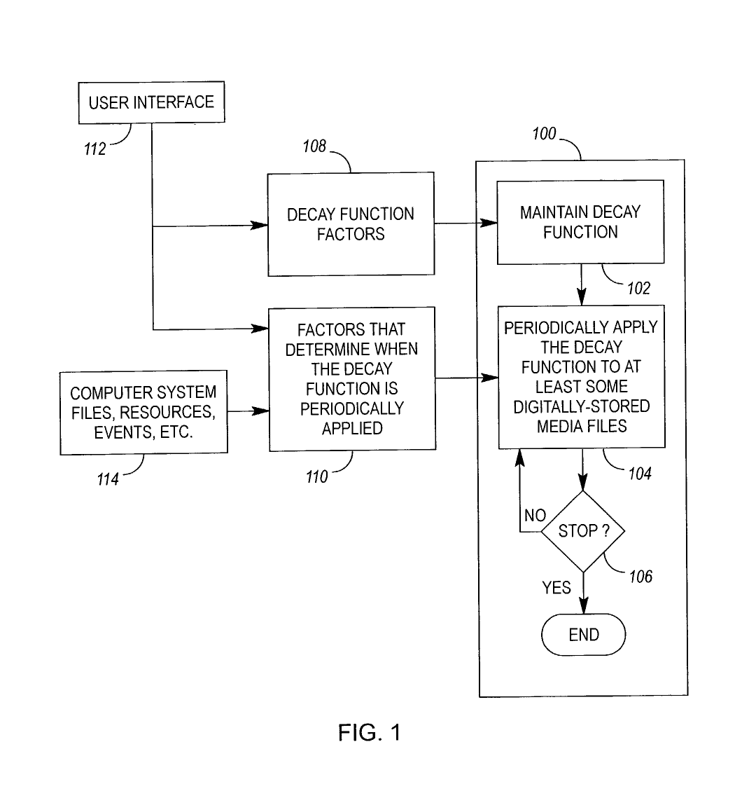

In accordance with one exemplary embodiment of the invention, a method 100 for managing digitally-stored files is illustrated in FIG. 1. The method 100 comprises maintaining 102 a decay function, and then periodically applying 104 the decay function to at least a portion of the afore-mentioned digitally-stored media files. At some point, and as will be discussed below, periodic application of the decay function may be stopped 106. In one embodiment of the invention, periodic application of the decay function is stopped after a certain number of repetitions, at which point the decayed file is deleted.

“Periodic application” is defined herein to mean “application from time-to-time based on the satisfaction of one or more parameters”. Thus, “periodic application” encompasses application at regular time intervals, application at intervals not based on time, and application at intervals based only partly on time.

The portion of digitally-stored media files to which the decay function is applied may comprise all media files, all image files, all audio files, all video files, all multimedia files, all files in specified directories, user-selected files, or other desired file groups or groupings.

The decay function is a function that specifies how to downsize one or more of the media files so as to free additional storage resources. Depending on the goal or goals to be achieved, the decay function may assume one or more of a variety of types, and therefore depend on a variety of factors 108. For example, the decay function may specify a decay in resolution of digitally-stored media files.

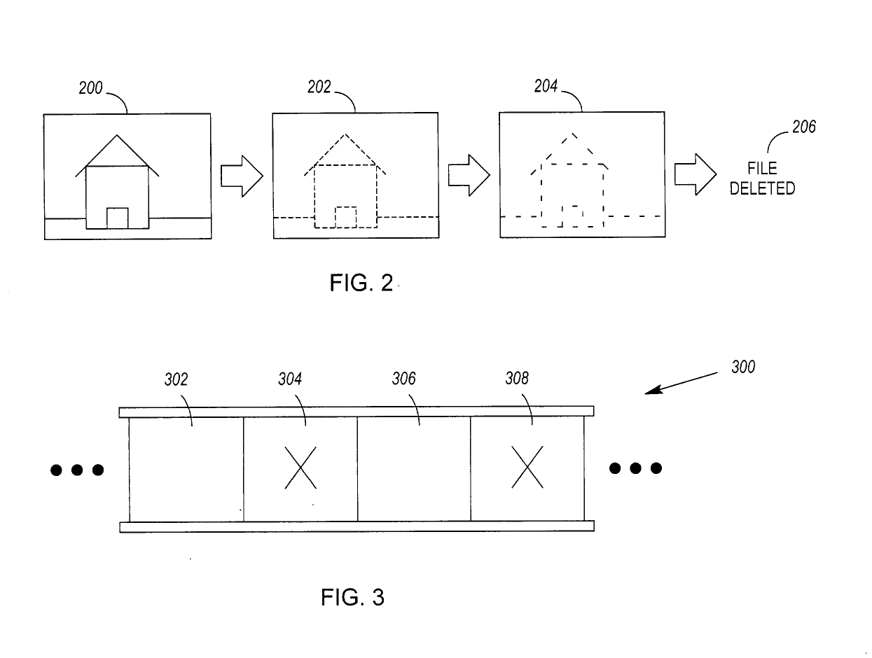

One form of decay in resolution is illustrated in FIG. 2. By way of example, FIG. 2 illustrates the contents of an image file 200 comprising a house. The image file 200 is originally stored at a desired resolution. After the first periodic application of the decay function, the size of the image file 200 is downsized 202. Although resolution is lost in the downsized image file 202, the loss of resolution may or may not be noticeable to a user who views the downsized image file 202 (e.g., the loss in resolution might only be noticeable when the image is magnified). After a second periodic application of the decay function (i.e., application of the decay function to the already downsized image file 202), the size of the image file 202 is further downsized 204, and additional resolution is lost. If desired, the decay function may be applied to the image file additional times, with each successive application producing a smaller image file with less resolution. Due to the fact that a point will be reached when the image file is no longer practically viewable, the image file 204 may be deleted 206, for example, after a specified number of applications of the decay function, or when the file 204 falls below a certain size. If desired, a user may be prompted before a file is deleted. A user may also be prompted before each application of the decay function. In one embodiment, the resolution of a TIFF (Tagged Image File Format) file is decayed by successively resaving it at lower specified DPIs (dots per inch).

The decay function may also specify a compression algorithm for digitally-stored media files. In one embodiment, a TIFF file is decayed through compression by first resaving it as a high resolution JPEG (Joint Photographic Experts Group), and then successively resaving it as lower resolution JPEGs. In this example, the resultant saved files 200, 202, 204 might appear as shown in FIG. 2 when viewed. In another embodiment, a video file is decayed through compression by successive deletion of frames. See, for example, FIG. 3, where every other frame 304, 308 of a video file 300 is shown to be deleted (indicated by the “x”s) during application of the decay function. If desired, the decay function may be applied to the video file 300 additional times, with each successive application producing a smaller video file with fewer frames. Due to the fact that a point will be reached when the video file is no longer practically viewable, the video file 300 may be deleted 1) after a specified number of applications of the decay function, 2) when the file 300 falls below a certain size, etc. If desired, a user may be prompted before a file is deleted. A user may also be prompted before each application of the decay function. With compression through frame deletion, the remaining frames 302, 306 of a video file 300 remain clear, but playback of the frames 302, 306 may result in “choppiness”. Note that decay through compression does not encompass the use of compression algorithms that provide for full recovery of an original media file.

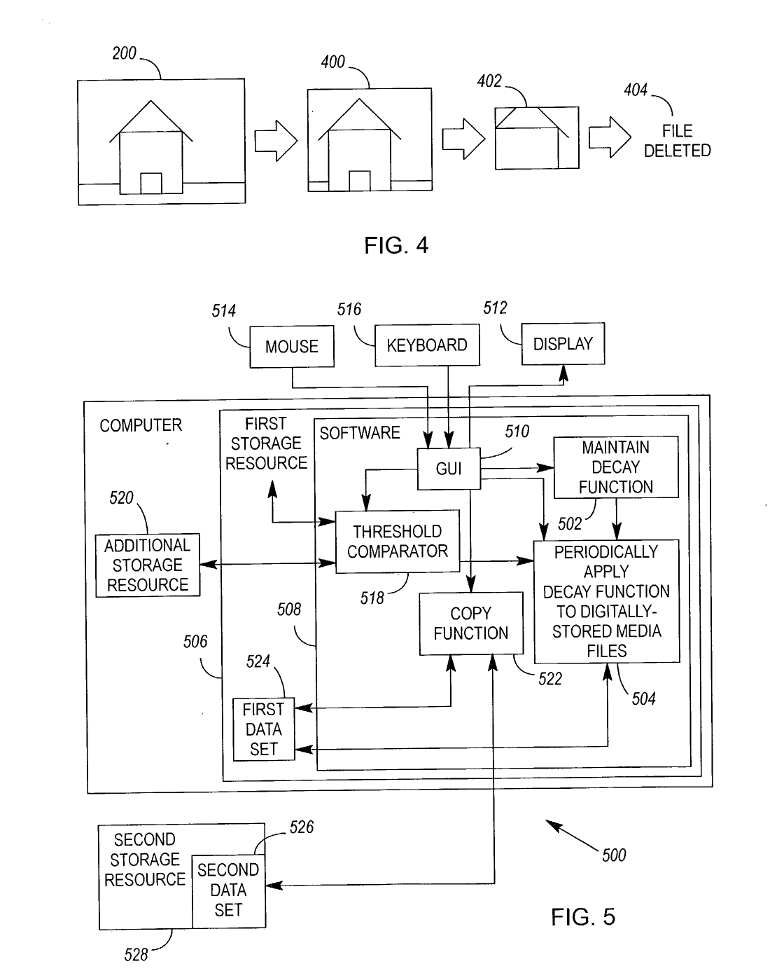

The decay function may also specify a cropping algorithm for digitally-stored media files. Application of a cropping algorithm is illustrated in FIG. 4. By way of example, FIG. 4 once again illustrates an image file 200 comprising a house. After the first periodic application of the decay function, the size of the image file 200 is downsized 400. Note that resolution is retained in the downsized image file 400, but specified portions of the original image file 200 are lost (e.g., a specified number of outermost pixels). After a second periodic application of the decay function (i.e., application of the decay function to the already cropped image file 400), the size of the image file 400 is further downsized 402, and additional portions of the original image 200 are lost. If desired, the decay function may be applied to the image file additional times, with each successive application producing a smaller image file with less image data. Due to the fact that a point will be reached when the image file is no longer practically viewable, the image file 402 may be deleted 404 1) after a specified number of applications of the decay function, 2) when the file 402 falls below a certain size, etc. If desired, a user may be prompted before a file is deleted. A user may also be prompted before each application of the decay function.

Although the above examples have discussed the application of decay functions to image and/or video files, the same or similar decay functions could also be applied to audio and/or multimedia files (i.e., combinations of image, audio and/or video files). For example, decay of an audio file through compression might involve removing specified frequency ranges from the file to thereby create a smaller audio file. Alternatively, decay of an audio file through cropping might involve deleting latter portions of an audio track.

The periodic application of a decay function may be controlled in a variety of ways, and be based on a number of factors 110 (see FIG. 1). In one embodiment, the periodic application of a decay function might depend on media files reaching at least one specified age. The age might be two weeks, one month, or one year. Alternatively, multiple ages might be specified via an interval (e.g., weekly, monthly, or semi-annually).

The periodic application of a decay function might also (or alternatively) depend on the state(s) and/or existence of various files, resources, events, etc. 114 (FIG. 1). For example, the periodic application of a decay function might depend on the availability of at least one storage resource falling below at least one specified threshold, such as the availability of a computer's local hard drive falling below 20%. In this example, the decay function would be applied to one or more media files stored on the local hard drive when the availability of the hard drive fell to below 20% (i.e., when more than 80% of the local hard drive was full). Note, however, that the periodic application of a decay function could also depend on other thresholds, such as the response time of a storage resource falling below a certain threshold.

In yet another embodiment, the periodic application of a decay function is dependent upon a specified rate of decay. For example, the rate of decay might be “slow”, “moderate”, or “fast”. The rate, in turn, might determine whether a decay function is applied weekly, monthly, or semi-annually.

The periodic application of a decay function could also depend on a combination of factors, including combinations of the factors set forth above.

Referring once again to FIG. 1, it should be noted that decay function factors 108, as well as factors that determine when a decay function should be periodically applied 110, can be provided and/or adjusted via a suitable user interface 112, as will be discussed in more detail later in this description.

Having described a method for managing digitally-stored media files, apparatus for managing digitally-stored media files will now be described. As illustrated in FIG. 5, the apparatus may comprise computer-readable media (e.g., storage resources 506, 528, 520 such as hard drives, floppy disks, or CD-ROMs (compact disc read only memories); RAM (random access memory)); etc.). The apparatus may also comprise program code (e.g., software 508 or firmware) stored on the computer-readable media. The program code may comprise program code 502 for maintaining a decay function, and program code 504 for periodically applying the decay function to at least a portion of the digitally-stored media files. In a preferred embodiment, the program code functions in accordance with the previously described method for managing digitally-stored media files.

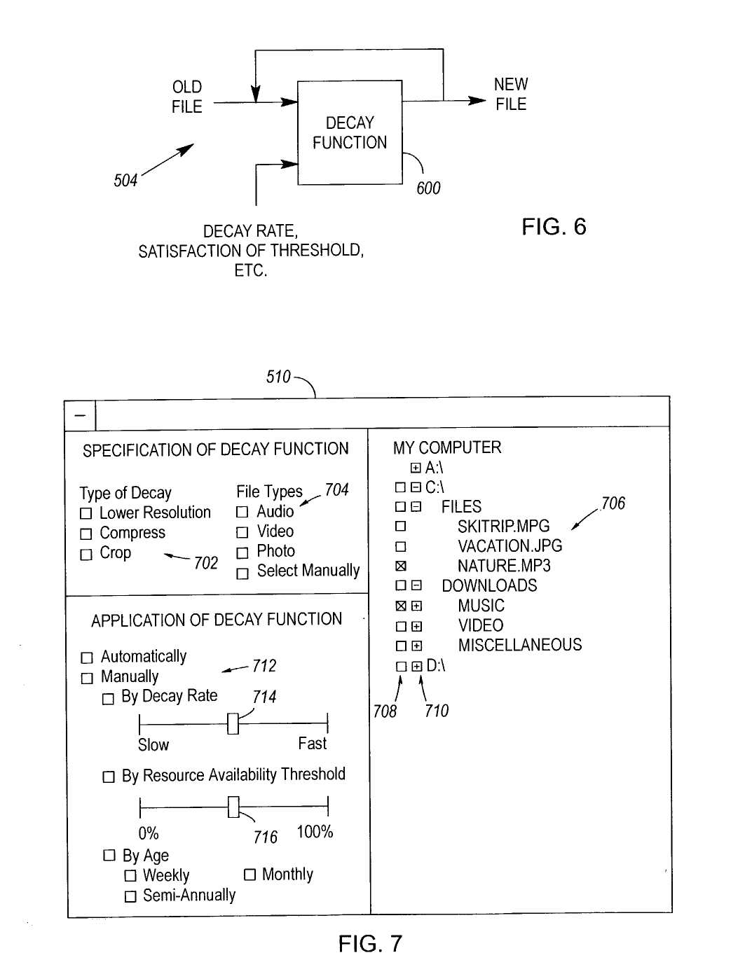

The program code 504 for periodically applying the decay function may be implemented as shown in FIG. 6. Note that an existing version of a media file (i.e., the “old file”) is processed in accordance with a decay function 600 to produce a new version of the media file (i.e., the “new file”). During successive applications of the decay function 600, a “new file” which was created during a previous application of the decay function 600 is processed by the decay function 600 as an “old file”. Application of the decay function 600 is controlled by one or more of a variety of factors, including decay rate, satisfaction of thresholds, and so on.

The apparatus for managing digitally-stored media files may further comprise program code for presenting a graphical user interface (GUI 510) to a computer user. The GUI 510 may comprise controls for receiving parameters of the decay function, and/or controls for receiving parameters for the periodic application of the decay function, in addition to other controls. A preferred embodiment of such a GUI 510 is illustrated in FIG. 7.

The GUI 510 illustrated in FIG. 7 illustrates a first number of controls 702, 704, 706 for receiving parameters of a decay function. One of these controls 702 is listed under the heading “SPECIFICATION OF DECAY FUNCTION” and the subheading “Type of Decay”. As its heading implies, this first control 702 is provided for the purpose of specifying a type of decay for the decay function. The possible types of decay shown in FIG. 7 correspond to the types of decay which have already been discussed herein (i.e., resolution lowering, compression, and cropping). However, other types of decay that are now known, or will be developed, may also be included. Depending upon the implementation of the GUI 510, a user is given the ability to select one or more of the decay types. In FIG. 7, the decay types are selected by clicking on a checkbox using an input device such as a mouse or keyboard.

A second control 704 of the GUI 510 is provided for the purpose of selecting a portion of digitally-stored media files to which a decay function will be applied. This second control 704 is listed under the heading “SPECIFICATION OF DECAY FUNCTION” and the subheading “File Types”. In the embodiment shown, a user may click on a checkbox to select audio, video or photo files in general, or alternatively, may click on a checkbox for the purpose of manually selecting the media files to which a decay function will be applied. In FIG. 7, selection of the “Select Manually” option enables a directory listing 706 from which desired media files can be selected. In a Microsoft® Windows® environment, the directory listing may be implemented, for example, using a Windows® Explorer type directory structure. In such a structure, the contents of directories may be expanded and contracted by respectively clicking on “+” or “−” boxes 710 corresponding to various ones of the directories. For the purpose of file selection, it is convenient to provide a file selection checkbox 708 next to each directory and file displayed. In this manner, clicking a checkbox next to a file selects the file, and clicking a checkbox next to a directory selects all of the files in the directory. In an alternate embodiment of file selection, the directory listing 706 could be used to select those files to which a decay function should never be applied (i.e., to select files which a user desires to keep forever, or until further notice).

The GUI 510 illustrated in FIG. 7 further illustrates a second number of controls 712 for receiving parameters for the periodic application of a decay function. The second number of controls 712 provide for applying a decay function “Automatically” or “Manually”. Automatic application of a decay function may be configured in a variety of ways, including those that may be manually selected by a user. Manual application of a decay function is shown in FIG. 7 to comprise three sub-types. However, other sub-types could also be provided.

A first sub-type of manual decay function application is “By Decay Rate”. This sub-type may be implemented, for example, by a slider control. Movement of the slider “handle” 714 by means of a mouse or other input device allows a user to specify a decay rate component of a decay function. For example, decay rate might be specified as “Slow”, “Fast”, or something in between.

A second sub-type of manual decay function application is “By Resource Availability Threshold”. This sub-type may also be implemented by a slider control. Movement of the slider “handle” 716 by means of a mouse or other input device allows a user to specify when program code 504 for periodically applying a decay function is triggered. In one embodiment, the “resource” referred to might be a local hard drive, and the “resource availability threshold” might be anything between 0% and 100%.

It should be noted that a “resource availability threshold” is just one type of “storage resource threshold” that might be implemented. Other thresholds might include “resource response time”. In general, a “storage resource threshold” is any threshold, the satisfaction of which triggers program code 504 to periodically apply a decay function.

A third sub-type of manual decay function application is “By Age”. In FIG. 7, this sub-type is shown to be implemented via checkboxes that enable a user to alternately select “Weekly”, “Monthly”, or “Semi-Annually”. Thus, a user may specify one or more file ages that will trigger program code 504 for periodic application of a decay function.

Returning now to FIG. 5, additional aspects of apparatus for managing digitally-stored media files will be described.

The GUI 510 may be displayed to a user via a display 512 such as a CRT (cathode ray tube) or LCD (liquid crystal display). User input to the GUI 510 may be received by a variety of input devices including, for example, a mouse 514, keyboard 516, trackball, glide pad, or pen tablet. As has already been discussed, the GUI 510 may receive parameters of a decay function 502 and parameters for the periodic application of a decay function 504 (including a storage resource threshold). A threshold comparator 518, for example, may receive a storage resource threshold input through the GUI 510, and then process data received from a first and/or additional storage resources 506, 520 for the purpose of determining whether the threshold(s) have been met. When the threshold(s) are met, program code 504 for periodically applying a decay function may be triggered.

The FIG. 5 apparatus may further implement a copy function 522. One purpose of the copy function is to replace at least one media file in a first data set 524 with a copy of a corresponding media file in a second data set 526 upon a user's indication that the quality of the at least one file in the first data set 524 needs to be improved. The quality of files in the first data set may need to be improved, for example, when a user wants to look at a file in the first set after the file has decayed beyond recognition. The second data set 526 therefore serves as a backup of the first data set 524. Preferably, the second data set 526 is created before any decay of the first data set 524. In this manner, any file in the first data set 524 may be replaced with its corresponding original in the second data set 526, and files that have been wholly deleted from the first data set 524 may be re-supplied to the first data set 524. Also, preferably, the second data set 526 is stored on a second storage resource 528 (or resources) that is better able to manage a large number of digitally-stored media files. By way of example, the second storage resource 528 might be an online storage repository. When files in the second data set 526 are restored to the first data set 524, the files that become part of the first data set 524 preferably begin their decay cycle once again. In this manner, a user's working storage resources are not needlessly cluttered with infrequently used (and possibly large) media files. Yet a user may still obtain a “known good” or “known better” copy of a media file that has decayed.

What is claimed is:

1. A method for managing digitally-stored media files, comprising:
a) maintaining a decay function; and
b) periodically applying the decay function to at least a portion of the digitally-stored media files.

2. A method as in claim 1, wherein the decay function specifies a decay in resolution of digitally-stored media files.

3. A method as in claim 1, wherein the decay function specifies a compression algorithm for digitally-stored media files.

4. A method as in claim 1, wherein the decay function specifies a cropping algorithm for digitally-stored media files.

5. A method as in claim 1, wherein the periodic application of the decay function is dependent upon media files reaching at least one specified age.

6. A method as in claim 1, wherein periodic application of the decay function is dependent upon the availability of at least one storage resource falling below at least one specified threshold.

7. A method as in claim 1, wherein periodic application of the decay function is dependent upon a specified rate of decay.

8. A method as in claim 1, further comprising, providing a graphical user interface for user control of the decay function.

9. A method as in claim 1, further comprising, providing a graphical user interface for user control of the periodic application of the decay function.

10. A method as in claim 1, further comprising, providing an interface for user selection of the portion of digitally-stored media files to which the decay function is applied.

11. A method as in claim 1, wherein the portion of digitally-stored media files to which the decay function is applied is selected from the group consisting of image files, audio files, video files, and multimedia files.

12. A method as in claim 1, wherein:
a) said digitally-stored media files comprise:
i) a first data set stored on a first storage resource; and
ii) a second data set stored on a second storage resource, wherein the second data set is a backup of the first data set;
b) the portion of digitally-stored media files to which the decay function is applied comprises media files in said first data set; and
c) the method further comprises replacing at least one file in the first data set with a copy of a corresponding file in the second data set upon a user's indication that the quality of the at least one file in the first data set needs to be improved.

13. Apparatus for managing digitally-stored media files, comprising:
a) computer-readable media; and
b) program code stored on the computer-readable media, the program code comprising:
i) program code for maintaining a decay function; and
ii) program code for periodically applying the decay function to at least a portion of the digitally-stored media files.

14. Apparatus as in claim 13, further comprising program code for presenting an interface to a computer user, wherein the interface comprises controls for receiving parameters of the decay function.

15. Apparatus as in claim 14, wherein the interface is a graphical user interface (GUI).

16. Apparatus as in claim 14, wherein said controls comprise a control for specifying a type of decay for said decay function.

17. Apparatus as in claim 14, wherein at least one of said controls is a slider.

18. Apparatus as in claim 13, further comprising program code for presenting an interface to a computer user, wherein the interface comprises controls for receiving parameters for the periodic application of the decay function.

19. Apparatus as in claim 18, wherein said controls comprise a control for specifying a decay rate component of said decay function.

20. Apparatus as in claim 18, wherein:
a) said controls comprise a control for specifying at least one storage resource threshold; and
b) said program code for periodically applying the decay function is triggered by satisfaction of said storage resource threshold.

21. Apparatus as in claim 18, wherein said controls comprise a control for specifying a file age.
